(19) United States
(12) Patent Application Publication
(10) Pub. No.: US 2014/0319850 A1
(43) Pub. Date: Oct. 30, 2014

(54) MAGNETIC DOOR LOCK ASSEMBLY

(71) Applicant: Securitech Group, Inc., (unknown)

(72) Inventors: Mark J. BERGER, New York, NY (US); Jeffrey REGEN, Riverhead, NY (US); Peter ZOLTAN, Maspeth, NY (US)

(73) Assignee: Securitech Group, Inc.

(21) Appl. No.: 14/216,027

(22) Filed: Mar. 17, 2014

Related U.S. Application Data
(60) Provisional application No. 61/791,998, filed on Mar. 15, 2013.

(51) Int. Cl. E05C 1/08

(52) U.S. Cl. CPC E05C 1/085
USPC 292/177

(57) ABSTRACT

A latch lock system for a door that is mountable in a doorframe, the latch lock system including a main housing including a spindle and lever, a bolt having a nose part that is attractable to a magnet, the bolt being slidable in the main housing between extended and retracted positions, a spring biasing the bolt to its retracted position, a secondary housing including a strike plate in the doorframe, a magnet mounted in the secondary housing, the magnet having a magnetic force greater than the spring force which will pull the bolt to its extended position when the door is in its closed position and the bolt is aligned with the magnet.

### RELATED CASE

This application claims priority under 35 USC Sections 119 and/or 120 of Provisional Patent Application Ser. No. 61/791, 998 filed Mar. 15, 2013, owned by the present applicant, the contents of which are incorporated herein by reference,

### FIELD OF THE INVENTION

This invention is in the field of door lock assemblies and particularly the interaction of a moving bolt of the lock assembly and a cooperating strike plate in a doorframe.

### BACKGROUND AND PRIOR ART

Door latch assemblies are well known in the prior art including both spring-biased bolts and deadbolts which engage a strike plate in a door frame. A characteristic of spring-biased moving bolts is that the bolt is always resiliently biased to its extended or open position whether the door is open or closed, with the distal part of the bolt inserted into the aperture of a strike plate. When a door closes and the bolt head initially engages the exposed edge of a strike plate, the bolt will momentarily be pushed inwardly against the spring force, and with further pivoting of the door which may be less than one inch, the bolt then moves outward by said spring force into the strike plate aperture and door latching is complete. This is an almost universal arrangement for automatic latching to occur whenever a door is pivoted to its closed position, so that there is no requirement for a user to manually latch a closed door to keep it from reopening. This is in contrast to a deadbolt which may be driven manually, or by key operation via a lock cylinder or other independent actuation.

An inherent characteristic of a spring-biased bolt is that after it is momentarily pushed into its retracted position against the spring force, which occurs as the bolt engages an edge of the strike plate, this bolt then springs outward or distally into the aperture of the strike plate, until such motion is blocked (a) by a stop element engaging the proximal or other portion of the bolt, or (b) by a stop element located in the door frame or located inwardly of the strike plate. Regardless of the exact mechanism in the latch assembly that stops the outward motion of the moving bolt, this stopping invariably causes a significant amount of sound in all manner of locks from doors in rooms, automobile doors and frames, luggage locks, etc. In many cases the sound is annoying or distracting and sometimes detrimental as described below.

In patient rooms in hospitals this clicking or clacking door-closing noise is a particular and potentially serious problem. Typically in hospitals, nurses must enter patients' rooms frequently and at all hours of the day and night, where the door latch clacking would repeatedly awaken other patients in the room not being treated by that particular visit of the nurse. Furthermore, door latch clacking in one room would create disturbing noise to patients in adjacent rooms.

Typical prior art patents and applications which disclose and/or pertain to door latches and door levers include the following publications which are incorporated here with by reference: applicants co-pending application Ser. Nos. 12/590,135 and 12/856,811 and 29/416,689 and other U.S. Pat. Nos. 6,351,976; 4,236,396; 1,463,341; 6,742,820; 5,529,354; 5,947,535; 5,658,026; 4,502,720; and published applications 2010/0072762 and 2006/0071484.

The above-described door latch noise situations have been in existence for decades if not hundreds of years, operating with the same fundamental noise issue every time the door is closed. The present invention addresses this situation and provides a new structure that substantially overcomes the noise problem described above.

### OBJECTS AND SUMMARY OF THE INVENTION

A first object of the present invention is to provide a door latch structure which will allow a latch to automatically engage and lock with a strike plate with a relatively quiet operation.

A further object is to provide a door latch structure where the bolt is maintained in a retracted state while the doors open, and when the door is closed a magnet or other element draws the bolt to its latch state extending through the aperture in the strike plate in the doorframe.

An additional object is to provide a door latch structure as described above where the magnetic force attracting the bolt is adjustable by varying the axial position of the magnet in the strike plate assembly.

A still additional object is to provide a door latch structure as described above which includes a sound damping element situated either in the strike plate subassembly or in the latch assembly in the door, which either slows the movement of the bolt so that it does not impact against a stop element, or by other means deadens the sound of the bolt reaching its stop position.

Another object is to provide a door latch structure is described above with a shoulder or other radially extending element from the bolt's proximal area that engages a stop or retarding element fixedly positioned in the latch assembly.

A further object is to control or vary the speed and/or force of the moving bolt by coupling a hydraulic piston to the bolt stem, or by placing a cushion or other brake element in the path of the bolt, or by engaging the bolt or bolt stem, or creating some other friction feature.

Another object is to vary the magnet force by choosing a material with more or less magnetic force or by choosing a bolt head material that has more or less response to a magnetic field.

The objects are further set forth as embodiments listed below.

1. A latch lock system for a door that is mountable in a door frame, said door when pivoted to a closed position has a side edge aligned with said door frame, said latch lock system, comprising:
a. a main housing mountable in a door and including a spindle and lever,
b. a bolt having a body part and at one end a nose part that is attractable to a magnet, said bolt being slidable in said main housing between:

i. an extended position where said nose part extends transversely to be external of the side edge of the door, and

ii. a retracted position where said nose part is inward of said side edge of said door,

c. a spring mounted in said main housing and biasing said bolt to said retracted position with a spring retraction force Fs,
d. a secondary housing including a strike plate mountable in said door frame generally adjacent said main housing in said door, and
e. a magnet mounted in said secondary housing to be generally aligned with said nose part of said bolt in said main housing in said door, said magnet having a magnetic force Fm which is greater than said spring force Fs and which will pull said bolt to its extended position when said door is in its closed position and said bolt is aligned with said magnet,
f. said spindle being coupled to said bolt's body part, said spindle being movable between:

i. a release position where it allows said bolt to freely move between the bolt's retracted and extended positions, as said bolt is drawn by said spring force Fs and magnetic force Fm respectively, and

ii. and engage position where said spindle drives said bolt to the bolt's retracted position, thus overcoming said magnetic force Fm pulling said bolt toward its extended position.

2. The latch lock system according to Claim 1, where said secondary housing defines a recess opening with a front claim through which said bolt extends in its extended position, said magnet being positionable in said secondary housing at different distances from said front plane to vary the magnetic force Fm applicable to said nose part of said bolt.
3. The latch lock system according to Claim, where said spring in said main housing is adjustable to vary its spring force Fs biasing said bolt toward its retracted position
4. The latch lock system according to Claim 1, further comprising a second magnet in said nose part of said bolt to enhance magnetic attraction between said bolt and said magnet in said secondary housing.
5. The latch lock system according to Claim 4, where said second magnet is axially positionable at different distances relative to said side edge of said door to vary the bolt's attractability to said magnet in said secondary housing in said door frame.
6. The latch lock system according to Claim 1, comprising: (a) a keylock cylinder in said main housing spaced apart from said spindle, and (b) a pivotable link having (i) a proximal part drivable by said keylock cylinder, and (ii) a distal part engageable to said bolt's body part to restrain said bolt in its extended position, notwithstanding any force applied by said spindle to move said bolt to its retracted position.
7. The latch lock system according to Claim 1, further comprising a shock absorbing element engaged to said bolt in said main housing to reduce shock and noise of said bolt when moved to its extended position.
8. The latch lock system according to Claim 7, wherein said shock absorbing element is a spring mounted in said main housing and engaging said bolt.
9. The latch lock system according to Claim 7, where said shock absorbing element is a hydraulic cylinder and piston combination.
10. The latch lock system according to Claim 1, further comprising a shock absorbing element in said secondary housing engaged by said bolt nose part to reduce shock and noise of said bolt, when said bolt is moved to its extended position.
11. The latch lock system according to Claim 10, wherein said secondary housing comprises a strike plate with a recess into which said bolt nose part extends in its extended position, and said shock absorbing element is a resilient liner on the surface of said recess in said secondary housing.
12. The latch lock system according to Claim 1, wherein said secondary housing comprises a strike plate with a recess into which said bolt nose part extends in its extended position, said bolt nose part converges to a smaller cross-section at its distal part, and said recess is defined by walls that converge inwardly to conform to the shape of said bolt's nose part.
13. The latch lock system according to Claim 1, further comprising (a) an additional secondary housing mountable in an upper part of said door frame, (b) an additional main housing and additional bolt mountable in an upper part of said door adjacent said additional secondary housing, and (c) a link coupled to said spindle to drive said bolt and additional bolt simultaneously to their respective retracted positions.

These and other objects will be evident from the drawings and descriptions herein.

### BRIEF DESCRIPTION OF THE DRAWINGS

FIG. 1 is a fragmentary exploded perspective view of a door with its latch bolt approaching the strike plate in a doorframe,

FIG. 2 is a front elevation view in section of the new latch assembly,

FIG. 3 is a fragmentary plan view in section of the latch assembly taken along line 3-3 in FIG. 2,

FIGS. 4A, 4B and 4C are sectional views taken along line 4-4 in FIG. 1 showing details of the magnet associated with the strike plate,

FIG. 4D is an elevation view of the strike plate,

FIG. 4E is a sectional view taken along line 4E-4E in FIG. 4D,

FIG. 4F is a sectional view taken along line 4F-4F in FIG. 4D

FIG. 5 is a fragmentary front elevation view of the door and frame of FIG. 1 shown in closed state,

FIG. 6 is a fragmentary plan view in section taken along line 6-6 in FIG. 5,

FIG. 6A is an and elevation view of the bolt,

FIG. 6B is a sectional view taken along line 6B-6B in FIG. 6A and

FIGS. 7 and 8 are schematic elevation views of the latch bolt mechanism coupled to the key lock cylinder.

### DETAILED DESCRIPTION OF THE PREFERRED EMBODIMENT

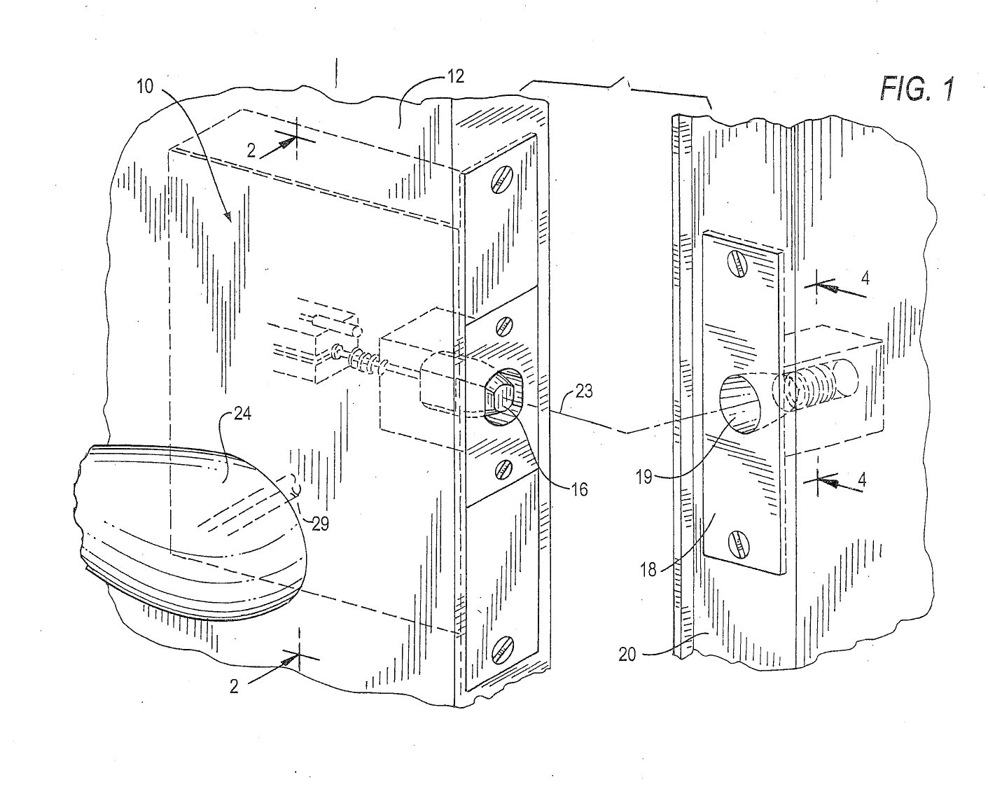

FIG. 1 illustrates the environment of the present invention which is a door latch assembly 10 situated in a door 12 that is pivotally mounted in a door frame where the door latch assembly's sliding bolt 16 can engage a strike plate 18 situated in door frame 20. Door 12 is shown in a partially open state with its bolt 16 situated to move along dashed line 23 into aperture 19 of strike plate 18 when door 12 completes pivoting to its closed position. Also shown in FIG. 1 is door lever 24 mounted pivotally on door 12 to cooperate with the latch assembly 10 for a person to manually pivot lever 24 to retract bolt 16 from its extended position in a strike plate when the door is closed.

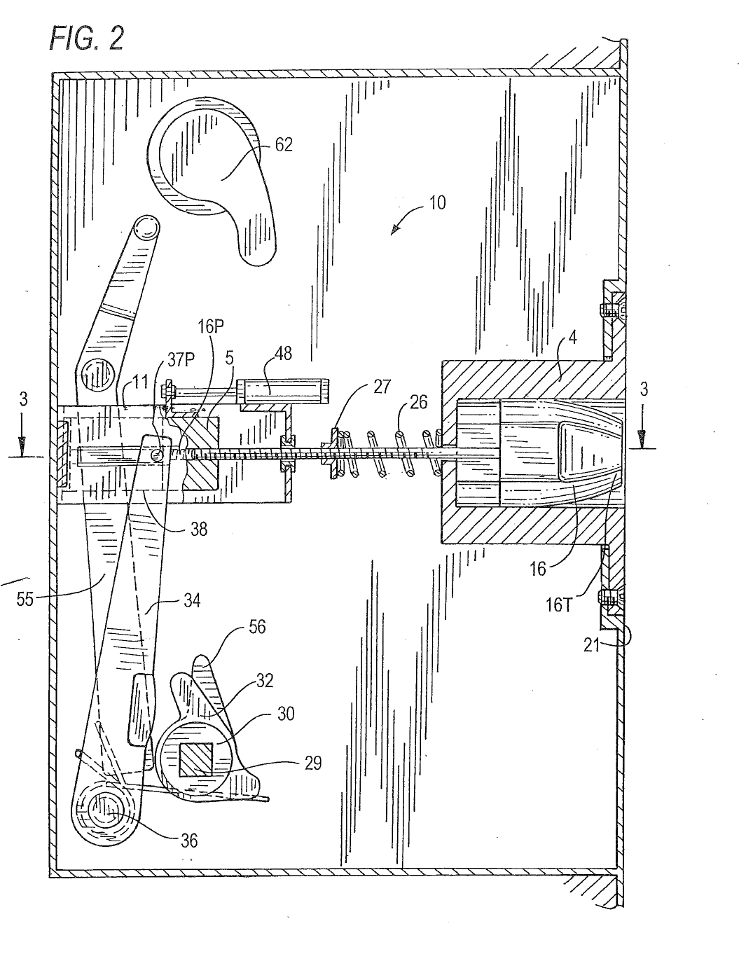

FIG. 2 illustrates the new latch assembly 10, shown for illustrative purpose, with its front plate removed. As seen, bolt 16 is situated in a retracted position so that its distal end or bolt head 16T does not extend outward of the edge surface 21 of latch housing 12. Bolt 16 can move axially outward to enter strike plate aperture 19 as seen in FIGS. 1 and 5; however, as seen in FIG. 3, extending proximally from bolt head 16T is bolt stem 28 with flange 27 intermediate the ends of this bolt stem. Coiled spring 26 encircles stem 28, with a distal end 26D of spring 26 bearing against frame 11, and proximal end 26P urging flange 27 and attached bolt stem 28 in the proximal or retracted position indicated by arrow 29. The proximal end 28P of stem 28 is coupled through the latch mechanism 10 to door lever spindle 29 and lever 24 as will be described below.

FIG. 5 shows door 12 having pivoted to its fully closed position within door frame 20, and with bolt 16 having moved axially and distally to its extended position where bolt head 16T has extended through aperture 19 of strike plate 18 also seen in FIG. 1.

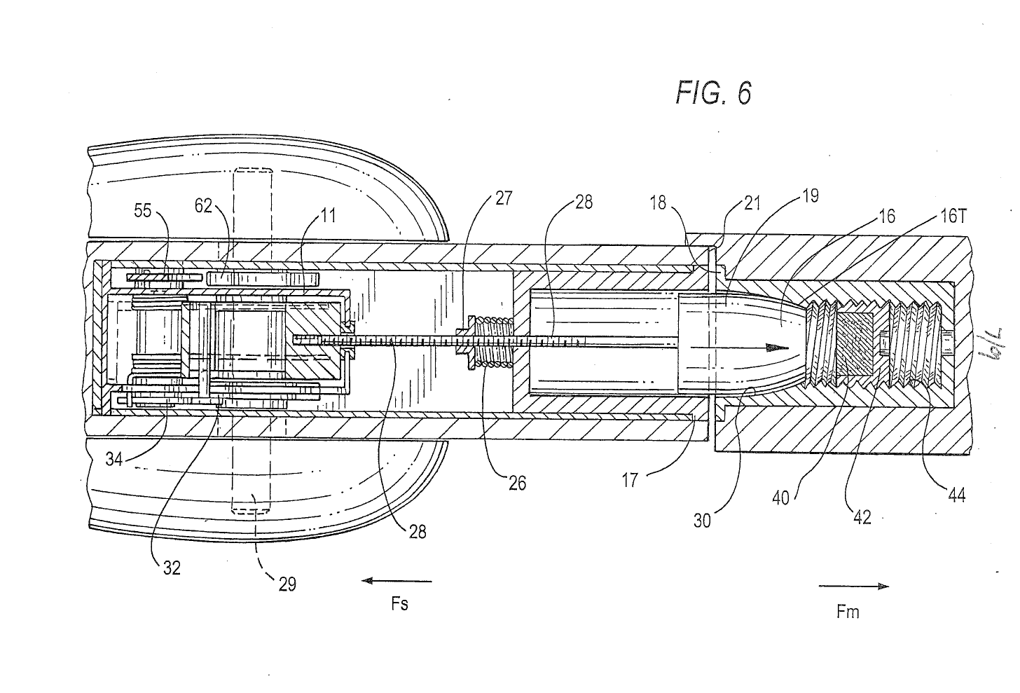

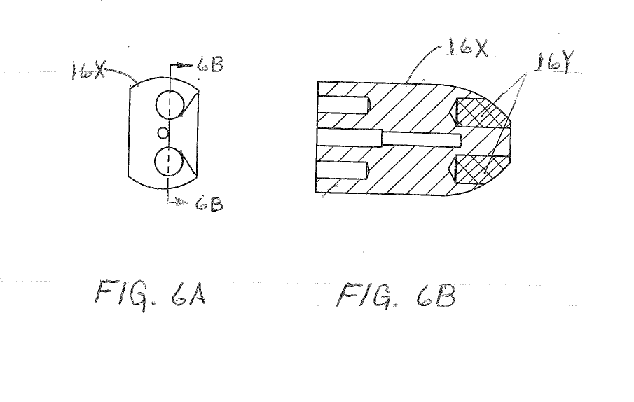

FIG. 6 is a top plan view in section similar to FIG. 3, taken along line 6-6 in FIG. 5, but showing bolt 16 in its extended position as also shown in FIG. 5. Accordingly, bolt head 16T has extended distally outward through cover plate 17 on the door edge 21. In this extended position, seen in FIG. 6, bolt stern 28 has simultaneously moved in the distal direction and spring 26 has been compressed. Transition of the bolt from its retracted to its extended state will occur when the door has been pivoted to its closed state so that bolt 16 is well aligned with aperture 19 in the strike plate, as seen in FIGS. 5 and 6.

FIG. 6 further illustrates bolt 16 having moved axially outward of door 12 and axially through aperture 19 of strike plate 18. Inwardly of strike plate 18 in the bolt-extended direction is a bolt-receiving area or chamber 30 conforming generally in shape to the outward surface of bolt head 16T. Further, inward of chamber 30 is magnet 40 which attracts bolt head 16T to move axially outward of door 20 and axially inward through the strike plate 18 and into chamber 30. When the door closes a magnetic force Fm (see arrow Fm) will pull bolt head 16T axially outward against said spring force Fs (see arrow Fs) of spring 26 since the magnetic force Fm is greater than the spring force Fs. In one preferred embodiment the magnet is of neodynium ¾″ in diameter and ⅜″ long with Surface Field=4667 Gauss and bolt travel of about ⅝″ to ¾″. Magnetic attraction between the bolt head and the magnet in the strike can be enhanced by addition of a secondary magnet(s) secured in the bolt head similar to the above-mentioned magnet of Neodynium ¼″ diameter by ⅜″ long, Surface Field=6261 Gauss.

FIG. 6A is a rear elevation view and FIG. 6B is a side elevation view in section of a lock bolt 16X with a pair of magnets 16Y installed in the bolt head to enhance magnetic attraction of the bolt into the strike when the door is closed. These magnets may be secured in the bolt head, for example by fit or glue.

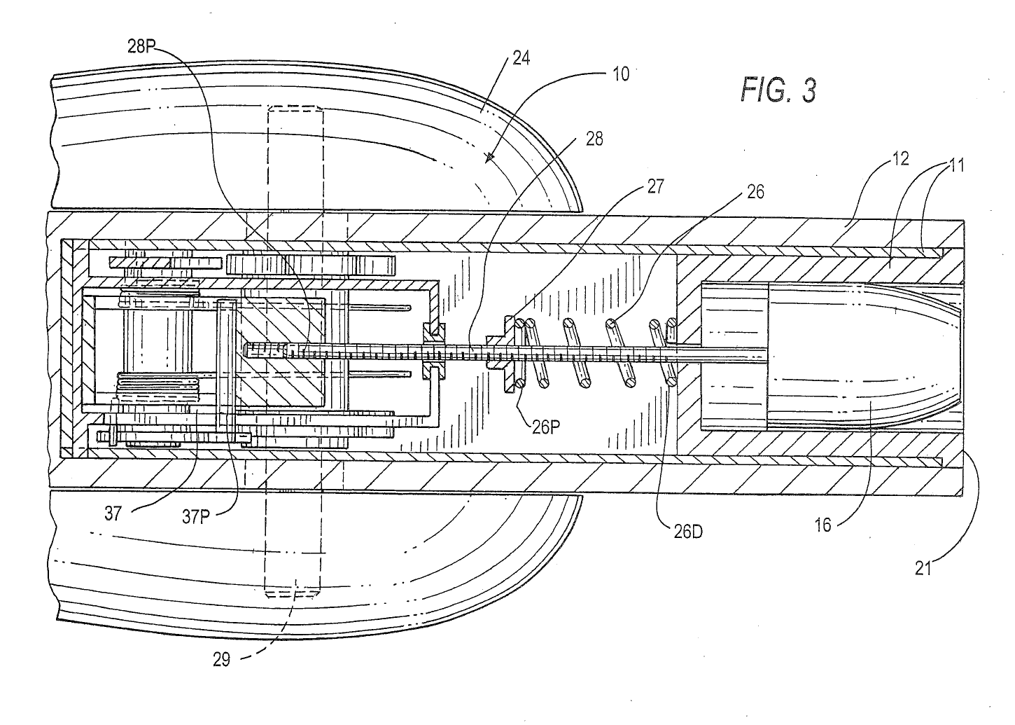

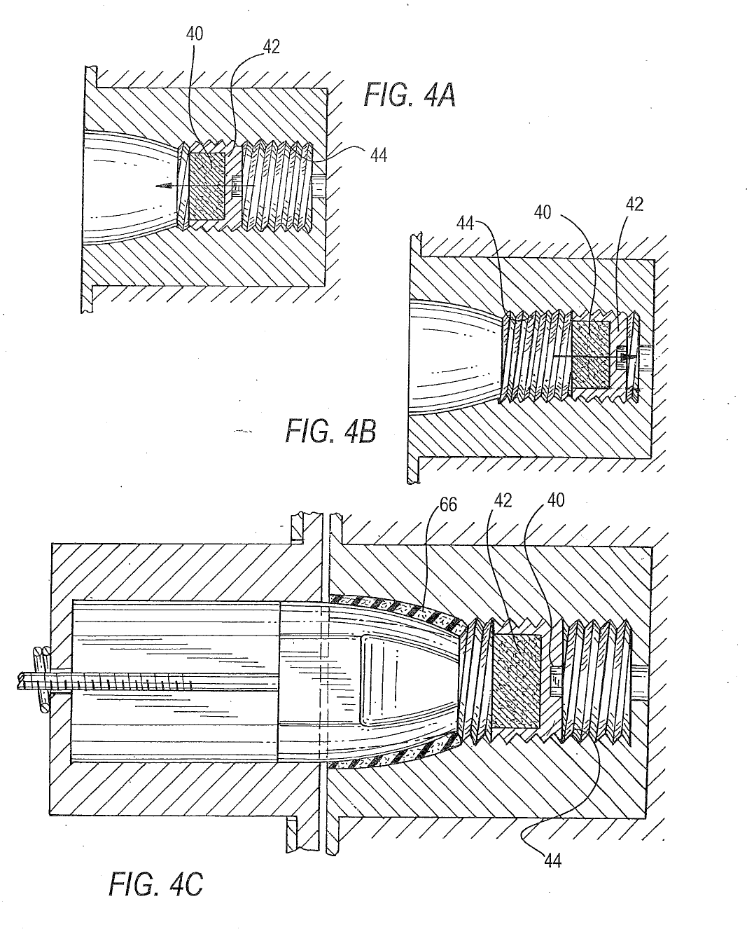

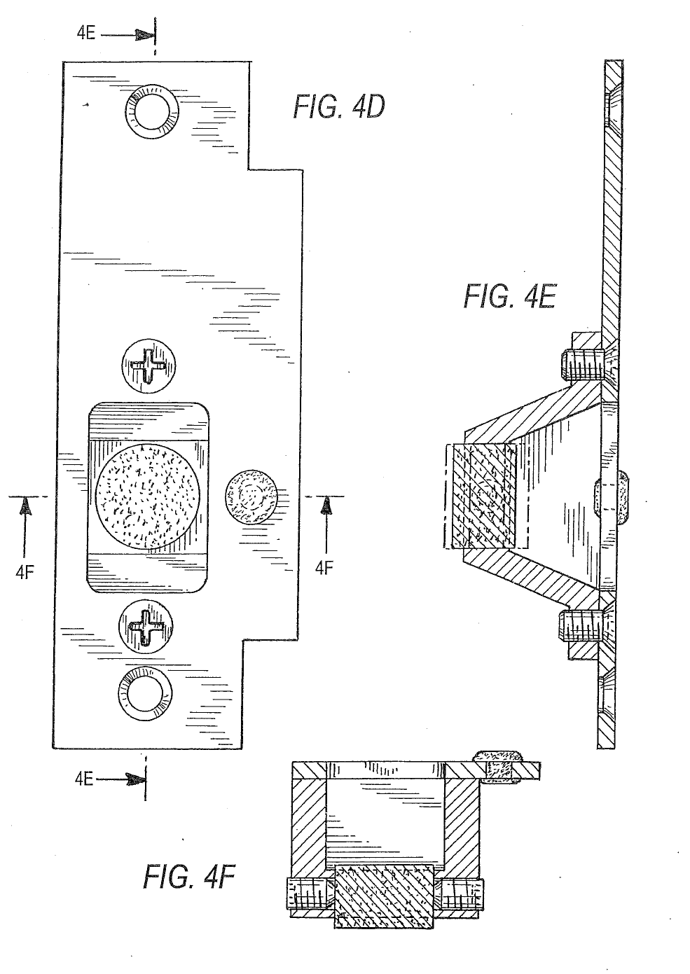

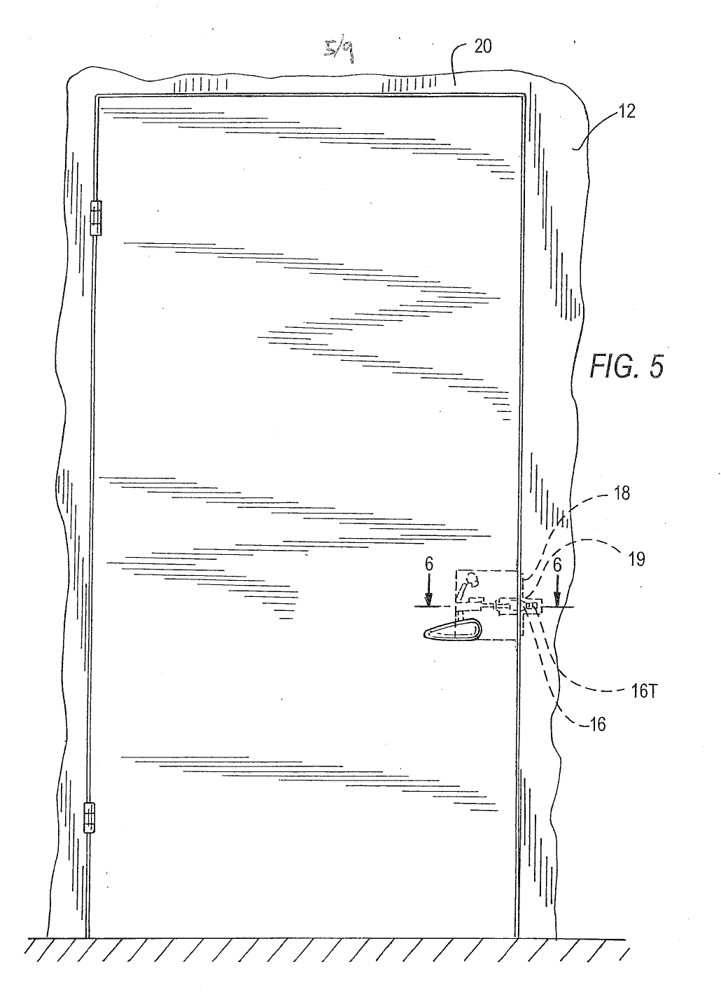

The axial force Fm of magnet 40 can be varied (a) by axially positioning magnet 40 closer to the strike plate as seen in FIG. 4A or farther from the strike plate as seen in FIG. 4B, or (b) by selecting a magnet having a greater or lesser magnetic force. An exemplary structure for axially moving magnet 40 is magnet holder 42 threadedly situated in threaded bore 44. Moving magnet 40 distally away per FIG. 4B will reduce the effective magnetic force and thus reduce the speed and/or impact of bolt head 16T into its extended position, and reduce the resultant noise when the doors closed.

FIGS. 4D-4F illustrate a preferred arrangement for adjustment of magnet 50 in the strike plate 18. Magnet 50 can be moved in the direction of arrow M and locked in place by set screws 52. Element 54 is a small projection or bumper or other friction element to slow down closing the door when it's edge approaches strike plate 18 in the door jam

Sound damping can also be achieved by a cushion 46 seen in FIG. 4C in front of magnet 40 or some other restrictive element in the vicinity of bolt head 16T, by a damper or shock absorber 48 seen in FIG. 1 or 2, may be applied to stem 16S of bolt 16 or applied to a movable frame 16F to which stem 16S is coupled. In a preferred embodiment the damper restricts bolt movement to 69 in/sec, while bolt may travel three times that speed without a damper.

To open a closed and latched door FIG. 1 shows a lever 24 that can be pivoted to rotate spindle 29 and retract bolt 16. Pivoting of lever 24 of a closed door will retract bolt 16 by manually overcoming the magnetic force Fm of magnet 40 situated inward of the strike plate. With the bolt 16 retracted and door 12 pivoted to an open position away from magnet 40, spring 26 would reassert its role of maintaining bolt 16 in its retracted mode.

In FIG. 2 is schematically shown a cam finger 32 rotated by spindle 29, coupled to lever 24 (not shown). Cam finger 32 engages link 34 which pivots about pivot axle 36 and has an arm portion 38 engaged to the proximal end 16P of bolt 16. To open a closed door, counterclockwise motion of spindle 29 drives link 34 in a counterclockwise motion which pulls bolt 16 into its retracted position which overcomes magnetic force Fm, and withdraws bolt 16 to be fully (proximally) outward of strike plate 18, so that the door can be opened. After the door is opened and magnet 40 is no longer affecting bolt head 16T, spring 26 can resume its primary role to maintain bolt 16 in its retracted position, regardless of whether lever 24 and link 34 are urging bolt 16 to its retracted position. Thus, when the door is open bolt 16 is normally retracted because of the spring force Fs. Bolt 16 will be extended only when the door is closed and the magnetic force Fm is applied, and finally will be pulled to its retracted position can be lengthened by an extension or other means not shown to compensate for a larger door Between the edge of the door and the door jam.

Also seen in FIG. 2 and three is coupling of the upper end 38 of link arm 34 to bolt stem 16S. Numerous different couplings well known in the prior art may be selected for retracting a bolt by rotation of a lever. This retraction also moves flange 27 in the proximal direction of arrow A1 which allows spring 26 to again exert force urging bolt stem 16S and bolt 16 to their retracted position. As noted above the magnetic force Fm is stronger than the spring force Fs, so that manual pivoting of lever 24 is required to overcome the magnet force. Thereafter, when the door is open and the lever is released, the spring force without opposition of a magnet force, will maintain the bolt in its retracted position, until such time as the door is closed again.

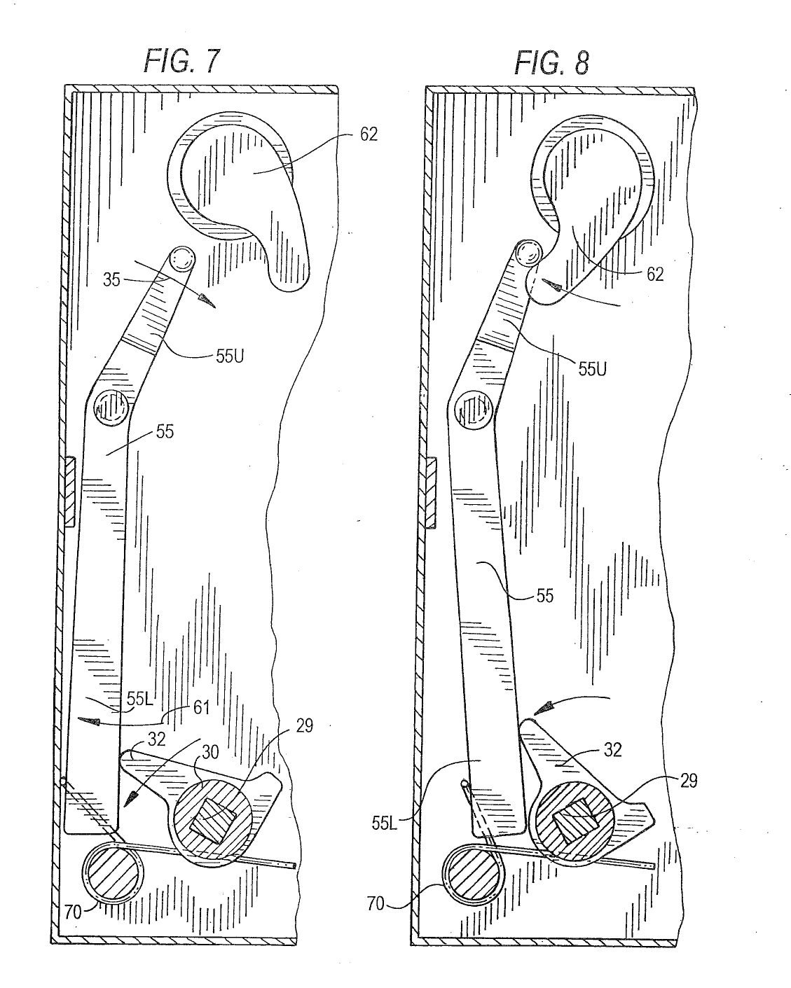

FIGS. 7 and 8 further illustrate how the independent keylock cylinder and its cam 62 can bar opening of this door when it is closed and its bolt is extended into the strike plate of the door frame. FIG. 7 shows that spindle 29 and its collar 31 6 and its camming finger 32 are positioned, if pivoted counterclockwise to bear against link 34 which would pivoted about pivot 36, and in so pivoting pull and retract the bolt. Pivoting of link 34 is precluded by cam finger 62 of keylock cylinder not shown, to thus bar opening the door by pushing on the lever.

FIG. 2 shows bolt head 16T slidable in front housing sleeve 4, and bolt stem 16S is slidable in rear housing sleeve 5. Link 34 is situated on the near side of rear housing sleeve 5 as viewed in FIG. 2, while blocking link 55 is situated on the far side of rear housing sleeve 5, namely on the far or opposite side of housing 5. Link 34 is coupled to the rear portion 16P of the bolt stem by a transverse pin extending from said stem into slot 37 and link 34 seen in FIG. 3. FIGS. 2 and 8 show more clearly that link 34 is in the foreground, while link 55 is behind or rearward of rear housing 5.

As will be further explained below, door lever 24 can be pivoted to cause bolt 16 to retract from strike 18 so that the door can be opened. Keylock cylinder with its cam finger 62 can be rotated to lock mode to temporarily bar door lever 24 from being able to open the door. These two functions are achieved through two different links coupled to the door lever as follows. FIG. 2 shows link 34 connected between spindle 29 (coupled to door lever 24 not shown) and stem 16S of bolt 16 as seen in FIG. 2. In FIG. 2 link 34 appears in the foreground adjacent one side of housing 11, of the latch assembly and coupled to the proximal end 16P of the bolt stem 16S via a pin 37P extending transversely from stem 16S into a slot 37 at the top end of link 34 (FIG. 3). Also seen in FIGS. 2, 6 and 8 in the background or far side of housing 11 is link 55 having its upper portion 55U coupled to keylock cylinder and its cam finger 62 and having its lower portion 55L coupled to spindle 29 with its collar 31 and cam finger 56. These links are also shown in the FIG. 6 plan view where cam finger 32 pivoted by collar 31 engages link 34, both in the foreground or near side of housing 11, while cam finger 62 engages link 55 in the rear or far side of housing 11. Further details of the foreground link 34 and background link 55 are explained as follows.

FIG. 2 shows link 34 coupled to the bolts rear stem rear stem 16P with bolt 16 in its retracted position and spring 26 in its expanded mode pushing and maintaining bolt 16 to remain in its retracted state until the door is closed and bolt 16 moves distally through strike 18 as seen in FIG. 6. This bolt can be retracted by rotating spindle 29, its collar 30 and its cam finger 32 counterclockwise as seen in FIG. 2 which would bear against link 34 and pull bolt stem 28 toward the left into its retracted state as seen in FIG. 2. Thus, the keylock cylinder in lock mode can block lever; however, if the keylock cylinder's cam finger 62 is pushing upper arm 55U of link 55 in a counterclockwise direction, this pushes lower arm 55L of link 55 into position adjacent cam finger 32 and blocks this finger and spindle 29 from turning to retract the bolt and opened the door.

Further as regards the damping feature applied to bolt 16 to reduce or eliminate the sound associated with the magnet pulling the bolt into the strike plate, an alternative damping element is a hydraulic piston and cylinder 48 as seen in FIG. 2 coupled through a linkage to bolt 16. This slows and controls the movement of the bolt when it is under the influence of the magnetic pull. This hydraulic cylinder can be adjusted to affect the speed and/or force of movement of the bolt. An alternative adjustment of the damping effect can be achieved, as described above and as shown in FIG. 6, by adjusting the position of magnet 40 to alter the magnetic force affecting the bolt head, and a still further alternative damping element would be positioning a cushion proximally of the surface of the magnet to blunt or soften the impact and resulting sound.

Returning now to FIG. 6, chamber 30 into which the bolt head 16T will be inserted is tapered to reduce the possibility of patient suicide as follows. If such patient were to position a segment of a cord, twisted sheet or other ligature into this chamber 30 recess, intending to have the ligament captured therein when the door is closed with the opposite end used as a noose, such ligament would tend to fall out or at least not be captured due to the tapered walls. Accordingly, with the spring element in the latching mechanism maintaining the bolt in a retracted state, a ligature inserted in said chamber would simply fall out when any tension were applied thereto since there was nothing on which the ligature could hook onto.

Although the best mode for carrying out the present invention has been described in the foregoing detailed description and illustrated in the accompanying drawings, it will be understood that the invention is not limited to the embodiments enclosed, but is capable of numerous rearrangements, modifications and substitutions of steps and elements without departing from the spirit of the invention. Accordingly, the present invention is intended to encompass such rearrangements, modifications and substitutions of steps and elements as falls within the scope of the claims.

1. A latch lock system for a door that is mountable in a door frame, said door when pivoted to a closed position has a side edge aligned with said door frame, said latch lock system, comprising:
a. a main housing mountable in a door and including a spindle and lever,
b. a bolt having a body part and at one end a nose part that is attractable to a magnet, said bolt being slidable in said main housing between:
i. an extended position where said nose part extends transversely to be external of the side edge of the door, and
ii. a retracted position where said nose part is inward of said side edge of said door,
c. a spring mounted in said main housing and biasing said bolt to said retracted position with a spring retraction force Fs,
d. a secondary housing including a strike plate mountable in said door frame generally adjacent said main housing in said door, and
e. a magnet mounted in said secondary housing to be generally aligned with said nose part of said bolt in said main housing in said door, said magnet having a magnetic force Fm which is greater than said spring force Fs and which will pull said bolt to its extended position when said door is in its closed position and said bolt is aligned with said magnet,
f. said spindle being coupled to said bolt's body part, said spindle being movable between:
i. a release position where it allows said bolt to freely move between the bolt's retracted and extended positions, as said bolt is drawn by said spring force Fs and magnetic force Fm respectively, and
ii. and engage position where said spindle drives said bolt to the bolt's retracted position, thus overcoming said magnetic force Fm pulling said bolt toward its extended position.

2. The latch lock system according to claim 1, where said secondary housing defines a recess opening with a front claim through which said bolt extends in its extended position, said magnet being positionable in said secondary housing at different distances from said front plane to vary the magnetic force Fm applicable to said nose part of said bolt.

3. The latch lock system according to claim 2, where said spring in said main housing is adjustable to vary its spring force Fs biasing said bolt toward its retracted position

4. The latch lock system according to claim 1, further comprising a second magnet in said nose part of said bolt to enhance magnetic attraction between said bolt and said magnet in said secondary housing.

5. The latch lock system according to claim 4, where said second magnet is axially positionable at different distances relative to said side edge of said door to vary the bolt's attractability to said magnet in said secondary housing in said door frame.

6. The latch lock system according to claim 1, comprising: (a) a keylock cylinder in said main housing spaced apart from said spindle, and (b) a pivotable link having (i) a proximal part drivable by said keylock cylinder, and (ii) a distal part engageable to said bolt's body part to restrain said bolt in its extended position, notwithstanding any force applied by said spindle to move said bolt to its retracted position.

7. The latch lock system according to claim 1, further comprising a shock absorbing element engaged to said bolt in said main housing to reduce shock and noise of said bolt when moved to its extended position.

8. The latch lock system according to claim 7, wherein said shock absorbing element is a spring mounted in said main housing and engaging said bolt.

9. The latch lock system according to claim 7, where said shock absorbing element is a hydraulic cylinder and piston combination.

10. The latch lock system according to claim 1, further comprising a shock absorbing element in said secondary housing engaged by said bolt nose part to reduce shock and noise of said bolt, when said bolt is moved to its extended position.

11. The latch lock system according to claim 10, wherein said secondary housing comprises a strike plate with a recess into which said bolt nose part extends in its extended position, and said shock absorbing element is a resilient liner on the surface of said recess in said secondary housing.

12. The latch lock system according to claim 1, wherein said secondary housing comprises a strike plate with a recess into which said bolt nose part extends in its extended position, said bolt nose part converges to a smaller cross-section at its distal part, and said recess is defined by walls that converge inwardly to conform to the shape of said bolt's nose part.

13. The latch lock system according to claim 1, further comprising (a) an additional secondary housing mountable in an upper part of said door frame, (b) an additional main housing and additional bolt mountable in an upper part of said door adjacent said additional secondary housing, and (c) a link coupled to said spindle to drive said bolt and additional bolt simultaneously to their respective retracted positions.
